(19) United States
(12) Patent Application Publication
(10) Pub. No.: US 2011/0170005 A1
(43) Pub. Date: Jul. 14, 2011

(54) AUTOMATIC SWITCHING BETWEEN SIMULCAST VIDEO SIGNALS IN A MOBILE MEDIA DEVICE

(75) Inventors: Gilad Bornstein, Haifa (IL); Eitan Yacobi, Zichron YaHacov (IL); Constantine Elster, Haifa (IL)

(73) Assignee: Qualcomm Incorporated, San Diego, CA (US)

(21) Appl. No.: 12/687,788

(22) Filed: Jan. 14, 2010

(51) Int. Cl. H04N 5/46; G08B 21/00; H04N 5/66

(52) U.S. Cl. 348/555; 340/669; 348/739; 348/E05.114; 348/E05.133

(57) ABSTRACT

A mobile media device may preemptively switch from a terrestrial video signal of a simulcast to a mobile video signal of the same simulcast upon detecting displacement motion. In one example, an apparatus includes a display configured to display video data, and a signal selection unit configured to determine whether the apparatus is moving, wherein the signal selection unit is configured to cause the display to display video data from a terrestrial signal of a simulcast broadcast when the apparatus does not detect displacement motion, and wherein the signal selection unit is configured to cause the display to display video data from a mobile signal of the simulcast broadcast when the signal selection unit detects displacement motion. In this manner, the apparatus may avoid loss of data from the terrestrial video signal that may be caused while moving.

### TECHNICAL FIELD

This disclosure relates to mobile media devices that receive and display video.

### BACKGROUND

Mobile media devices, such as mobile telephones, mobile televisions, wireless media players, or the like, may receive and display over-the-air, wireless video signals, such as digital television broadcasts. Many broadcasters now broadcast video signals using a process referred to as “simulcast,” in which the broadcasters simultaneously broadcast two or more corresponding video signals: a terrestrial signal intended for stationary media devices and a mobile signal intended for mobile media devices.

In general, it may be difficult for a mobile media device to properly receive the terrestrial signal while the mobile device is moving, e.g., while a user who is holding the device is in a vehicle or is walking. On the other hand, the mobile signal can be more easily received by mobile devices, even while the devices are undergoing motion. However, the video data produced from the mobile signal has relatively lower quality, e.g., lower spatial or temporal resolution or lower bit rate, than video data produced from the terrestrial signal.

### SUMMARY

In general, this disclosure describes techniques for automatically switching between simulcast video signals in a mobile media device. A mobile media device may be configured to receive both a terrestrial video signal and a mobile video signal. In accordance with the techniques of this disclosure, the mobile device may selectively receive and display video data from the terrestrial video signal when the device is not moving, but receive and display video data from the mobile video signal when the mobile device is moving. The mobile device may be configured to determine whether the device is moving and selectively receive and display video data from a video signal that is selected according to whether the device is moving.

In one example, a method includes displaying, with a mobile media device, video data from a terrestrial signal of a simulcast broadcast when the mobile media device does not detect displacement motion, and displaying, with the mobile media device, video data from a mobile signal of the simulcast broadcast when the mobile media device detects displacement motion.

In another example, an apparatus includes a display configured to display video data, and a signal selection unit configured to determine whether the apparatus is moving, wherein the signal selection unit is configured to cause the display to display video data from a terrestrial signal of a simulcast broadcast when the apparatus does not detect displacement motion, and wherein the signal selection unit is configured to cause the display to display video data from a mobile signal of the simulcast broadcast when the signal selection unit detects displacement motion.

In another example, an apparatus includes means for displaying video data from a terrestrial signal of a simulcast broadcast when the mobile media device does not detect displacement motion, and means for displaying video data from a mobile signal of the simulcast broadcast when the mobile media device detects displacement motion.

In another example, a computer-readable medium, such as a computer-readable storage medium, is encoded with instructions that cause a programmable processor to display video data from a terrestrial signal of a simulcast broadcast when the mobile media device does not detect displacement motion, and display video data from a mobile signal of the simulcast broadcast when the mobile media device detects displacement motion.

In another example, a method includes receiving, with a mobile media device, only video data from a terrestrial video signal of a simulcast, determining that the mobile media device is moving, in response to determining that the mobile media device is moving, receiving a mobile video signal of the simulcast in addition to the terrestrial video signal, and displaying video data from the terrestrial video signal until an error is encountered.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system in which a mobile media device selects a video signal of a simulcast from which to receive and display video data based on whether mobile media device is moving

FIG. 2 is a block diagram illustrating components of an example mobile media device that selects a video signal from a simulcast based on whether mobile media device is moving.

FIG. 3 is a flow chart illustrating an example method for determining whether to display video data from a terrestrial video signal of a simulcast or a mobile video signal of the simulcast.

FIG. 4 is a flowchart illustrating an example method for determining whether a mobile media device is moving using a global positioning system (GPS) unit.

FIG. 5 is a flowchart illustrating an example method for determining whether a mobile media device is moving using an accelerometer.

FIG. 6 is a block diagram illustrating an example wireless communication device that displays video data from either a terrestrial video signal or a mobile video signal of a simulcast depending upon whether the wireless communication device determines that it is moving.

FIG. 7 is a conceptual diagram illustrating an example operation of a mobile media device during a portion of an example user's day.

FIG. 8 is a flowchart illustrating an example method for determining whether to receive video data from a mobile video signal of a simulcast based on displacement motion.

### DETAILED DESCRIPTION

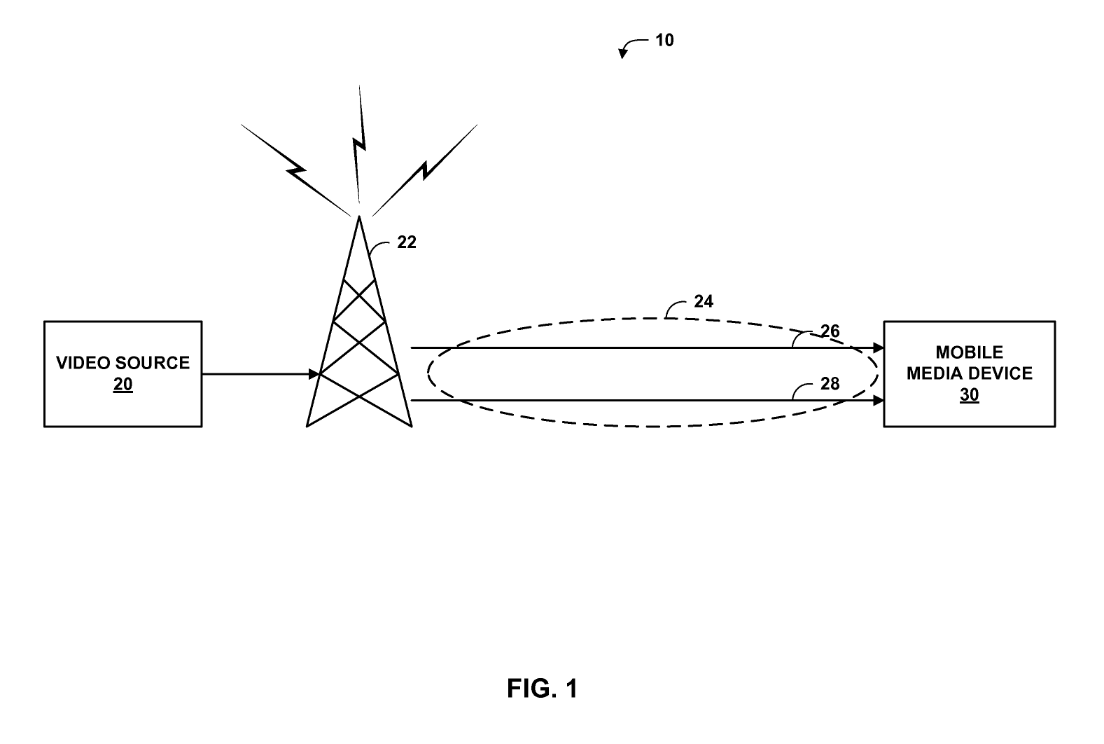

FIG. 1 is a block diagram illustrating an example system 10 in which mobile media device 30 selects a video signal from which to display video data based on whether mobile media device 30 is moving. In particular, mobile media device 30 selects either a terrestrial video signal or a mobile video signal based on whether mobile media device 30 is moving and then decodes video data from the selected signal and displays the decoded video data. In the example of FIG. 1, video source 20 provides video data to broadcaster 22. Video source 20 may provide the video data to broadcaster 22 as raw video data or encoded video data. Video source 20 may comprise, for example, a video recording and production studio, an archived video source, computer generated video, or any other pre-recorded or pre-generated video facility or source. In some examples, video source 20 and broadcaster 22 may be integrated units, but are depicted separately for purposes of example.

Broadcaster 22 may be configured to encode the video data received from video source 20 for broadcasting. In the example of FIG. 1, broadcaster 22 simulcasts two corresponding video signals. In particular, broadcaster 22 broadcasts terrestrial video signal 26 and mobile video signal 28, which together form simulcast 24. In general, terrestrial video signal 26 may comprise a relatively higher quality video signal intended for stationary video display devices, such as personal television sets, while mobile video signal 28 may comprise a relatively lower quality but more resilient video signal intended for mobile media devices, such as cellular telephones or mobile televisions.

Various video broadcasting standards exist for forming terrestrial and/or mobile video signals. Broadcaster 22 may broadcast terrestrial video signal 26 according to any terrestrial video signal standard and may broadcast mobile video signal 28 according to any mobile video signal standard. For example, broadcaster 22 may broadcast terrestrial video signal 26 as an Advanced Television Systems Committee (ATSC) terrestrial signal, an Integrated Services Digital Broadcasting (ISDB) full-segments transmission, or a Digital Video Broadcast terrestrial (DVB-T) signal. Likewise, broadcaster 22 may broadcast mobile video signal 28 as an ATSC mobile/handheld (ATSC-M/H) signal, an ISDB one-segment transmission, or a DVB handheld (DVB-H) signal.

Broadcaster 22 may simulcast terrestrial video signal 26 and mobile video signal 28 according to corresponding standards. As an example, when broadcaster 22 broadcasts terrestrial video signal 26 as an ATSC terrestrial video signal, broadcaster 22 may also broadcast mobile video signal 28 as an ATSC-M/H signal. However, broadcaster 22 may also broadcast simulcast 24 according to different standards for terrestrial video signal 26 and mobile video signal 28. Although not shown in FIG. 1, additional terrestrial display devices and/or mobile display devices may receive terrestrial video signal 26 and/or mobile video signal 28.

The term “simulcast” as used in this disclosure refers to a broadcast of at least two corresponding video signals, one of the video signals comprising a terrestrial video signal and the other video signal comprising a mobile video signal. The two signals are “simultaneous” in that video data corresponding to a particular time or scene in one signal is broadcast at exactly or nearly the same time as the video data corresponding to the same time or scene in the other signal. In this manner, video display devices receiving either signal may essentially display the same video content at approximately the same time. That is, assuming that a terrestrial display device was to display video data from terrestrial video signal 26 and that a mobile display device was configured to display video data from mobile video signal 28, the terrestrial display device and the mobile display device would display essentially the same content (albeit of different qualities) at nearly the same time.

In general, display of video data from terrestrial video signal 26 by a mobile video device can be difficult while the mobile video device is moving, as terrestrial video signal quality may deteriorate while a mobile video device is moving. The error proneness of a video signal may be influenced by many factors such as, for example, modulation that is used for the terrestrial video signal. As an example, ISDB-T full-seg transmissions use 64 quadrature amplitude modulation (QAM), which is relatively more error prone than ISDB-T one-seg, which uses quadrature phase-shift keying (QPSK) modulation.

Terrestrial television signals are generally designed to support standard definition (SD) and high definition (HD) level video, which requires very high bit rate (e.g., 5 Mbps to 18 Mbps), while mobile video signals are generally designed to accommodate relatively smaller-sized screens and require relatively lower bit rate (e.g., 0.5 to 1 Mbps). The relatively high bit rate requirement for terrestrial television has an impact on the high signal to noise ratio, since complicated modulations schemes are typically involved, such 64-QAM, which usually requires a better receiver with a better antenna. The high bit rate and high power reception requirements can be poorly answered in mobile device due to size, cost, and power supply. In the power level side, the terrestrial television signal is designed to be received with roof-top, directional, and high gained antennas, while the mobile devices are usually located in inferior locations such as indoor positions and dense urban streets. Mobile devices are generally equipped with omnidirectional short antennas with poor gain. As a direct result, mobile devices typically receive lower signal levels and support relatively lower bit rates, such as those for simple modulation schemes, for example, QPSK. Terrestrial television signal receivers are usually powered directly from an AC power source, which allows for receivers that achieve relatively better performance.

A mobile device may be in motion when the user is walking, driving, or otherwise moving. This means that the mobile video device may support fast channel variations (high Doppler spread) and a large span of signal level. The mobile television network generally transmits more information (such as, for example, more pilots or additional redundant data) to support such channels, as opposed to a terrestrial TV network. In addition, the network generally supports of the tradeoff between network deployment and mobility support in the signal parameters (such as, for example, OFDM signal guard interval value). Accordingly, a terrestrial video network design is generally less suitable to handle various mobile channels compared to a mobile video network.

Mobile video networks typically add additional Forward-Error-Correction layers (in general, additional redundant data) relative to terrestrial TV networks. For example, there is an additional Read-Solomon code layer in DVB-H compared to DVB-T that enables error detection and correction in the receiver. This is another main reason why terrestrial TV is more error prone than mobile TV. Accordingly, in general, receiving a terrestrial video signal with a mobile media device is typically challenging.

The techniques of this disclosure recognize the challenges of receiving a terrestrial video signal by a mobile display device. Mobile media device 30 may be configured to display video data from either terrestrial video signal 26 or mobile video signal 28 by receiving and decoding one of terrestrial video signal 26 or mobile video signal 28, based on whether mobile media device 30 is moving, in accordance with the example techniques of this disclosure. That is, mobile media device 30 may determine whether mobile media device 30 is moving and select either terrestrial video signal 26 or mobile video signal 28. In general, when mobile media device 30 is moving, mobile media device 30 may display video data from mobile video signal 28. Alternatively, when mobile media device 30 is stationary, mobile media device 30 may display video data from terrestrial video signal 26.

In this manner, rather than awaiting a loss of video data as may otherwise result from attempting to display video data from terrestrial video signal 26 while moving, mobile media device 30 may proactively switch to mobile video signal 28 when mobile media device 30 determines that it is moving. Accordingly, mobile media device 30 may provide users with a high quality viewing experience that avoids signal loss that may occur when a device moving attempts to display video data from a terrestrial video signal. That is, by switching to mobile video signal 28 from terrestrial video signal 26, mobile media device 30 can maintain a display of data from the video program being simulcast, rather than awaiting an error or other data loss that may be caused by attempting to receive and decode data from terrestrial video signal 26 while mobile media device 30 is moving.

The term “displacement motion” as used in this disclosure refers to motion that causes mobile media device 30 to travel between two distinct physical locations over a period of time. In general, when mobile media device 30 is said to be “moving,” the term “moving” refers to the act of displacement motion. Displacement motion generally corresponds to locomotion, e.g., associated with being physically carried by a user while the user is walking or while the user is being transported by a vehicle. Displacement motion generally does not include motion associated with a user who is not moving, but who may nevertheless be subjecting mobile media device 30 to motion in the sense of passing mobile media device 30 between the user's hands, raising, lowering, turning, twisting, or tilting mobile media device 30, or other such movement of mobile media device 30 by a user who is at rest.

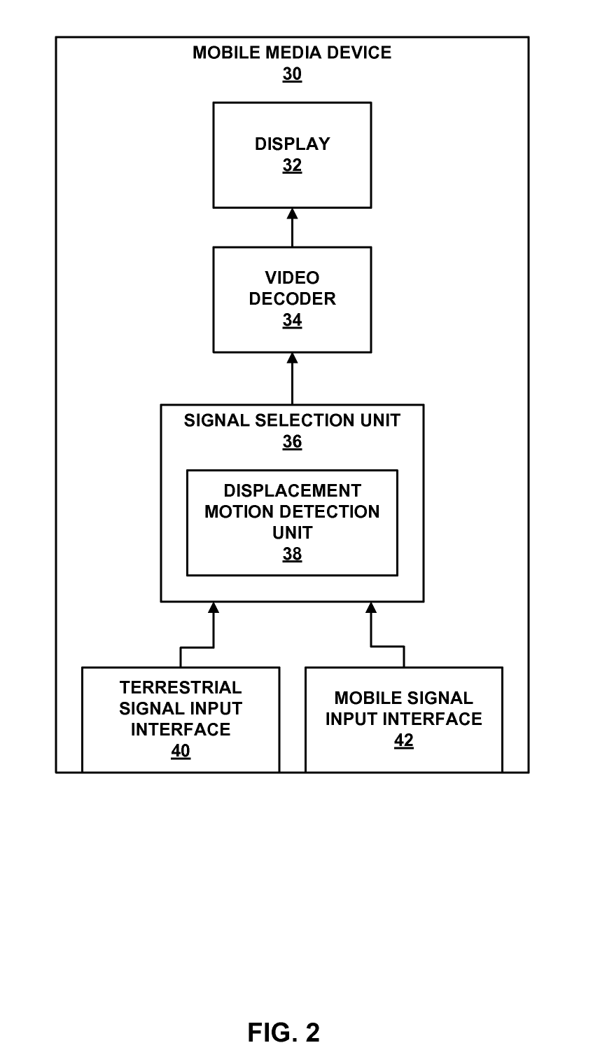

FIG. 2 is a block diagram illustrating components of an example mobile media device 30 that selects a video signal from a simulcast based on whether mobile media device 30 is moving. In the example of FIG. 2, mobile media device 30 includes display 32, video decoder 34, signal selection unit 36, displacement motion detection unit 38, terrestrial signal input interface 40, and mobile signal input interface 42.

For purposes of example, terrestrial signal input interface 40 and mobile signal input interface 42 are illustrated as separate units of mobile media device 30. However, it should be understood that in some examples, terrestrial signal input interface 40 and mobile signal input interface 42 may be functionally integrated, or may comprise the same unit. Either or both of terrestrial signal input interface 40 and mobile signal input interface 42 may comprise, for example, one or more antennae designed to receive video signals for television broadcasts. Mobile media device 30 receives terrestrial video signal 26 using terrestrial signal input interface 40 and receives mobile video signal 28 using mobile signal input interface 42.

Terrestrial signal input interface 40 may be configured to receive terrestrial video signals of one or more broadcast standards. For example, terrestrial signal input interface 40 may be configured to receive terrestrial video signals conforming to one or more of ATSC terrestrial, ISDB full-seg, and/or DVB-T. Similarly, mobile signal input interface 42 may be configured to receive mobile video signals of one or more broadcast standards. For example, mobile signal input interface 42 may be configured to receive mobile video signals conforming to one or more of ATSC-M/H, ISDB one-seg, or DVB-H. Each interface may include appropriate amplifier, filter, frequency conversion, and demodulation components to convert a received signal from transmit band to baseband.

When signal selection unit 36 selects the terrestrial video signal, terrestrial signal input interface 40 receives data from the terrestrial video signal, and then sends the data from the terrestrial video signal to signal selection unit 36. Likewise, when signal selection unit 36 selects the mobile video signal, mobile signal input interface 42 receives data from mobile video signal 28, and then decodes and sends the data from the mobile video signal to signal selection unit 36. In some examples, terrestrial signal input interface 40 may process data of terrestrial video signal 26 and mobile signal input interface 42 may process data of mobile video signal 28, e.g., to prepare the data for decoding.

Signal selection unit 36 is configured to determine whether data received by terrestrial signal input interface 40 or data received by mobile signal input interface 42 should be sent to video decoder 34 for decoding. In accordance with the techniques of this disclosure, signal selection unit 36 may interact with displacement motion detection unit 38 to determine whether mobile media device 30 is experiencing displacement motion.

Signal selection unit 36 and displacement motion detection unit 38 may be functionally integrated. Signal selection unit 36 and displacement motion detection unit 38 may each comprise any combination of hardware, software, and/or firmware. For example, signal selection unit 36 may correspond to a digital signal processor (DSP), a general purpose microprocessor, an application specific integrated circuits (ASIC), field programmable logic arrays (FPGAs), or other equivalent integrated or discrete logic circuitry. Alternatively or additionally, instructions for signal selection unit 36 and/or displacement motion detection unit 38 may be encoded in a computer-readable medium, such as a computer-readable storage medium, that cause a processor to perform the functions attributed to signal selection unit 36 and/or displacement motion detection unit 38.

Displacement motion detection unit 38 may comprise, in various examples, any combination of a motion sensor, such as an accelerometer, and/or a global positioning system (GPS) unit. For example, when displacement motion detection unit 38 comprises an accelerometer, the accelerometer may be configured to specifically detect displacement motion. Moreover, an accelerometer and a GPS unit may be used in conjunction to detect displacement motion. In some examples, a positive indication of displacement motion from an accelerometer causes displacement motion detection unit 38 to activate a GPS unit, which otherwise remains inactive (e.g., to conserve battery power), and to determine whether mobile media device 30 is moving based on data from the GPS unit. Alternatively, the accelerometer and the GPS unit may each provide indications of whether mobile media device 30 is moving, and displacement motion detection unit 38 may determine that mobile media device 30 is moving when either one of the accelerometer and the GPS unit indicate that mobile media device 30 is moving, or only when both the accelerometer and the GPS unit indicate that mobile media device 30 is moving.

As another example, when displacement motion detection unit 38 comprises one or more accelerometers, displacement motion detection unit 38 may store one or more motion signatures. Certain motion signatures may be designated as corresponding to displacement motion, while other motion signatures may be designated as not corresponding to displacement motion. Such signatures may be designed to match signals generated by the one or more accelerometers. In such examples, when the one or more accelerometers detect motion, a processing unit of displacement motion detection unit 38 may determine whether the motion corresponds to one of the signatures that is designated as corresponding to displacement motion. As an example, displacement motion detection unit 38 may comprise a one-, two-, or three-dimensional accelerometer that produces displacement vectors in different axes, such that if one of the vectors indicates relatively continuous or low frequency motion, the accelerometer indicates that mobile media device 30 is undergoing displacement motion, but for high frequency changes, e.g., caused by vibration, passing between a user's hands, or other non-displacement movement, the accelerometer indicates that mobile media device 30 is not undergoing displacement motion.

As still another example, when displacement motion detection unit 38 comprises a GPS unit, displacement motion detection unit 38 may be configured to periodically retrieve a location for mobile media device 30. Displacement motion detection unit 38 may further be configured to compare the current location with the previous location, e.g., to calculate the distance that was traveled within the period. When the calculated distance exceeds a threshold, displacement motion detection unit 38 may determine that mobile media device 30 is moving.

In any case, signal selection unit 36 may use displacement motion detection unit 38 to determine whether mobile media device 30 is moving. When displacement motion detection unit 38 indicates that mobile media device 30 is moving, signal selection unit 36 may select to receive video data from mobile signal input interface 42. When displacement motion detection unit 38 determines that mobile media device 30 is not moving, signal selection unit 36 may select to receive video data from terrestrial signal input interface 40.

Signal selection unit 36 may forward video data from the selected video signal, e.g., either terrestrial video signal 26 or mobile video signal 28, to video decoder 34 for decoding. Although only one video decoder 34 is shown for purposes of example in FIG. 2, in other examples, mobile media device 30 may comprise a plurality of video decoders. For example, mobile media device 30 may comprise individual video decoders for each of the received video signals.

Video decoder 34 may be configured to decode video data conforming to one or more various video coding standards. For example, video decoder 34 may be configured to decode video data conforming to one or more of MPEG-1 (motion picture experts group), MPEG-2, MPEG-4, international telecommunication unit (ITU) H.263, ITU H.264, ITU H.365, or other video encoding standards.

In another example, video decoder 34 may be coupled between the input interfaces and signal selection unit 36, such that signal selection unit 36 may select to receive and decode video data from terrestrial video signal 26 or mobile video signal 28 based on whether mobile media device 30 is moving, and pass the decoded video data to display 32.

Video decoder 34 may operate according to a video compression standard, such as the ITU-T H.264 standard, alternatively described as MPEG-4, Part 10, Advanced Video Coding (AVC). The techniques of this disclosure, however, are not limited to any particular coding standard. Other examples include MPEG-2 and ITU-T H.263. Although not shown in FIG. 2, in some aspects, video decoder 34 may be integrated with an audio decoder, and may include appropriate MUX-DEMUX units, or other hardware and software, to handle decoding of both audio and video in a common data stream or separate data streams. If applicable, MUX-DEMUX units may conform to the ITU H.223 multiplexer protocol, or other protocols such as the user datagram protocol (UDP).

Video decoder 34 may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Video decoder 34 may be included in one or more decoders, either of which may be integrated as part of a combined encoder/decoder (codec) in a respective camera, computer, mobile device, subscriber device, broadcast device, set-top box, server, or the like.

A video sequence typically includes a series of video frames. Video decoder 34 operates on video blocks within individual video frames in order to decode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction and 16 pixels in a horizontal direction. Likewise, an N×N block generally has N pixels in a vertical direction and N pixels in a horizontal direction, where N represents a positive integer value. The pixels in a block may be arranged in rows and columns.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered to be video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” or “coding unit” may refer to any independently decodable unit of a video frame or set of frames, such as an entire frame, a slice of a frame, a group of pictures (GOP) also referred to as a sequence of frames, or another independently decodable unit defined according to applicable coding techniques.

Mobile media device 30 is one example of an apparatus including a display configured to display video data, and a signal selection unit configured to determine whether the apparatus is moving, wherein the signal selection unit is configured to cause the display to display video data from a terrestrial signal of a simulcast broadcast when the mobile device does not detect displacement motion, and wherein the signal selection unit is configured to cause the display to display video data from a mobile signal of the simulcast broadcast when the signal selection unit detects displacement motion.

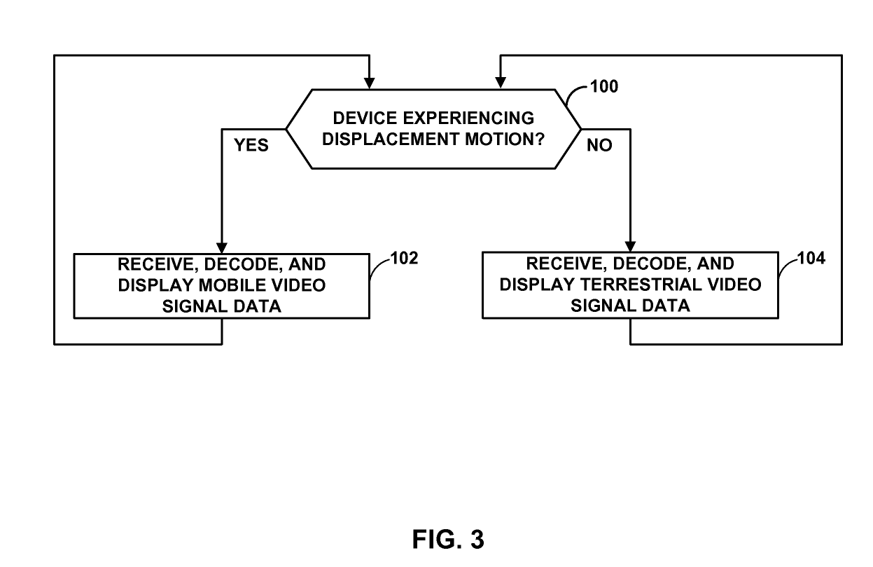

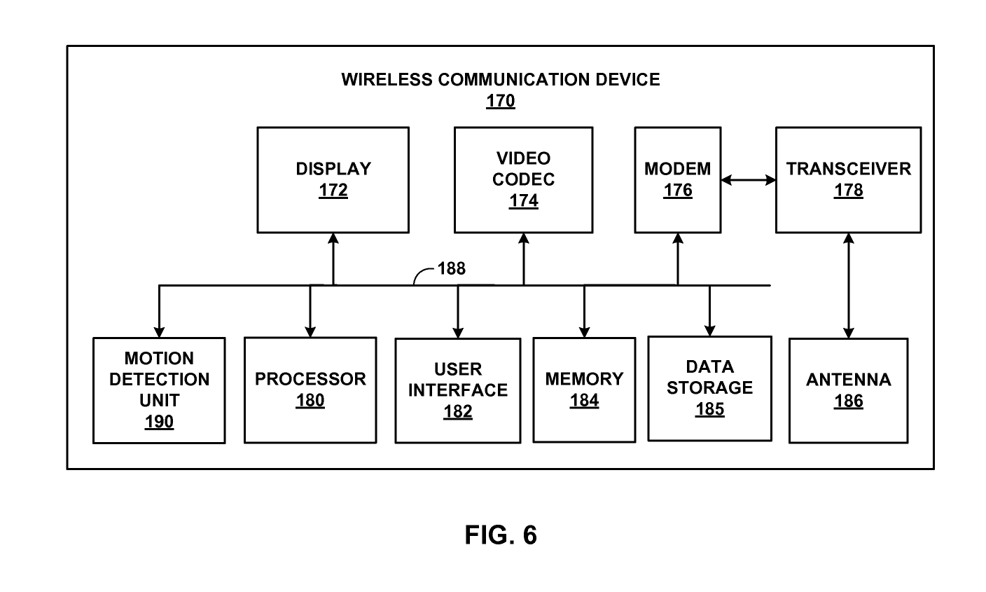

FIG. 3 is a flow chart illustrating an example method for determining whether to display video data from a terrestrial video signal of a simulcast or a mobile video signal of the simulcast. That is, the method of FIG. 3 includes selecting either a terrestrial video signal or a mobile video signal of a simulcast, based on whether a mobile media device is moving, and then receiving, decoding, and displaying video data from the selected video signal. Although described with respect to mobile media device 30 of FIG. 2 for purposes of explanation, it should be understood that other devices may be configured to perform the method described with respect to FIG. 3. For example, wireless communication device 170 of FIG. 6, described below, may be configured to perform the method of FIG. 3. Although in the example of FIG. 3 displacement motion directly indicates whether to receive and decode the terrestrial signal or the mobile signal, it should be understood that in other examples, whether mobile media device 30 is moving may be only one factor in a set of factors that determines whether to switch between the terrestrial signal and the mobile signal.

In the example of FIG. 3, displacement motion detection unit 38 may first determine whether mobile media device 30 is moving (100). In other examples, this determination may be made after receiving video data from terrestrial video signal 26 and mobile video signal 28 or in parallel with receiving video data from terrestrial video signal 26 and mobile video signal 28. Moreover, the determination of whether mobile media device 30 is moving need not necessarily correspond directly with receipt of video data from terrestrial video signal 26 and mobile video signal 28. Signal selection unit 36 may be configured, for example, to select either terrestrial signal input interface 40 or mobile signal input interface 42 independently of video data received by terrestrial video signal 26 and mobile video signal 28. In some examples, during a transition between receiving and decoding data from terrestrial video signal 26 and mobile video signal 28, both signals may be received and decoded, in order to provide a smooth transition between a display of video data from one signal to the other.

In some examples, signal selection unit 36 may be configured to perform the determination of whether mobile media device 30 is moving, using displacement motion detection unit 38, periodically, e.g., once every N seconds (e.g., 1 second, 10 seconds, 15 seconds, 30 seconds, etc.) or for a unit of video data, e.g., once every N video frames or once every N groups of pictures (GOPs). In still other examples, signal selection unit 36 may continuously determine whether mobile media device 30 is moving, and when displacement motion detection unit 38 determines that the displacement motion determination has changed (e.g., that mobile media device 30 is no longer experiencing displacement motion or has begun to experience displacement motion), signal selection unit 36 may switch the video signal selection.

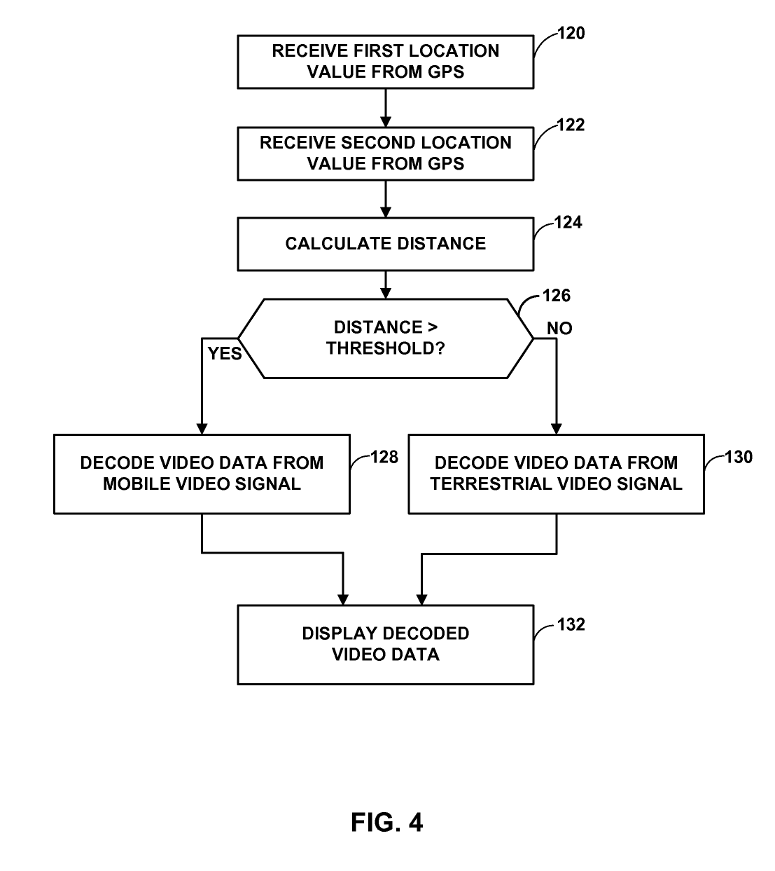

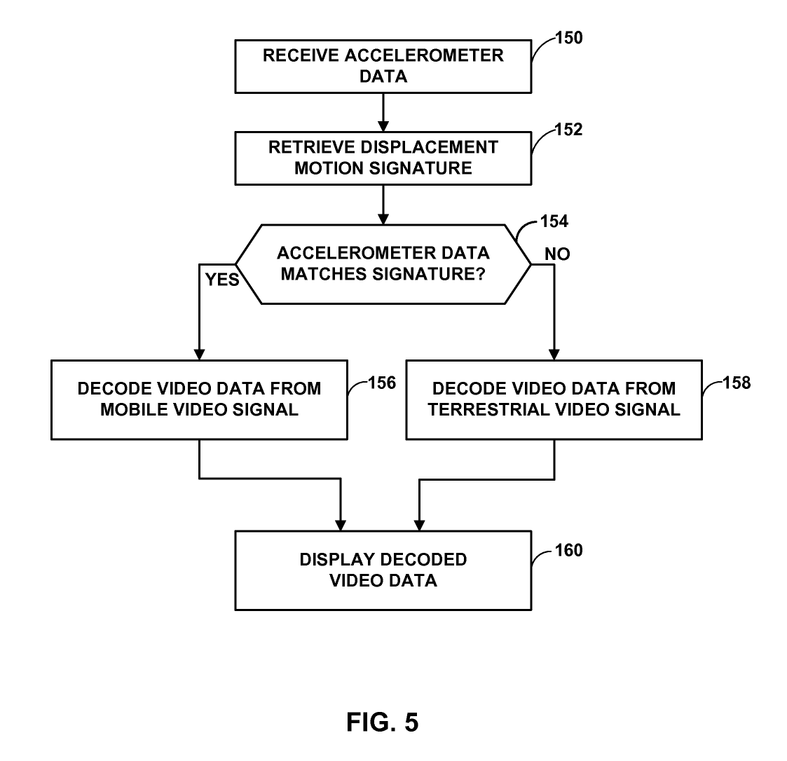

Displacement motion detection unit 38 may determine whether mobile media device 30 is moving in any suitable manner. In one example, displacement motion detection unit 38 may comprise a GPS unit and determine whether mobile media device 30 is moving by comparing locations indicated by the GPS unit over time, e.g., as discussed in greater detail with respect to FIG. 4. In another example, displacement motion detection unit 38 may comprise an accelerometer and determine whether mobile media device 30 is moving by comparing data produced by the accelerometer to one or more displacement motion signatures indicative of displacement motion, as described in greater detail with respect to FIG. 5. In still another example, displacement motion detection unit 38 may comprise any combination of a GPS unit, an accelerometer, and/or a motion sensor and determine whether mobile media device 30 is moving using a combination of these methods.

When displacement motion detection unit 38 indicates that mobile media device 30 is moving (“YES” branch of 100), signal selection unit 36 selects mobile video signal 28. Accordingly, video decoder 34 receives and decodes video data from mobile video signal 28, and sends the decoded video data to display 32 for display (102). On the other hand, when displacement motion detection unit 38 indicates that mobile media device 30 is not moving (“NO” branch of 100), signal selection unit 36 selects terrestrial video signal 26. Accordingly, video decoder 34 receives and decodes video data from terrestrial video signal 26, and sends the decoded video data to display 32 for display (104).

Subsequently, mobile media device 30 may again determine whether mobile media device 30 is moving. As noted above, the receipt of video data from terrestrial video signal 26 and mobile video signal 28 may be, but is not necessarily, related to the determination of whether mobile media device 30 is moving.

In this manner, mobile media device 30 may be configured to switch between a terrestrial video signal and a mobile video signal based on whether mobile media device 30 is moving, e.g., based on whether mobile media device 30 is undergoing displacement motion (locomotion). Thus, rather than waiting for a loss of data to occur as may happen while moving and displaying data from a terrestrial video signal before switching to a mobile video signal, mobile media device 30 may preemptively switch to the mobile video signal before loss of data occurs, in response to detecting displacement motion. Switching from a terrestrial video signal to a mobile video signal may be referred to as “fallback.” By performing fallback before a video break (that is, a loss of a terrestrial video signal), mobile media device 30 may prevent interruptions to the user's viewing experience, because mobile media device 30 may be prepared ahead of a deterioration of quality. Moreover, when a user later becomes stationary, mobile media device 30 may detect that it is no longer experiencing displacement motion and can switch back to the terrestrial video signal.

To summarize, an example method corresponding to FIG. 3 includes displaying, with a mobile media device, video data from a terrestrial signal of a simulcast broadcast when the mobile media device does not detect displacement motion, and displaying, with the mobile media device, video data from a mobile signal of the simulcast broadcast when the mobile media device detects displacement motion. The method may further include determining whether the mobile media device is moving, e.g., with at least one of a motion sensor, an accelerometer, or a GPS unit, as discussed below with respect to the examples of FIGS. 4 and 5.

FIG. 4 is a flowchart illustrating an example method for determining whether a mobile media device is moving using a GPS unit. Although described with respect to mobile media device 30 of FIG. 2 for purposes of explanation, it should be understood that other devices may be configured to perform the method described with respect to FIG. 4. For example, wireless communication device 170 of FIG. 6, described below, may be configured to perform the method of FIG. 4.

In the example of FIG. 4, displacement motion detection unit 38 comprises a GPS unit and, at a first time, receives a first location value from the GPS unit (120). At a second time, displacement motion detection unit 38 receives a second location value from the GPS unit (122). Although only two location values are used in the example of FIG. 4, in some examples, displacement motion detection unit 38 may receive any number of location values to be used for determining whether mobile media device 30 is moving.

Displacement motion detection unit 38, in the example of FIG. 4, calculates the distance between the first location and the second location (124). When displacement motion detection unit 38 is configured to use more than two locations, displacement motion detection unit 38 may calculate distances between successive locations. In some examples, motion detection unit 38 may, when configured to use more than two locations, calculate distances from the first location value to the subsequent location values, and periodically reset the “first” location, e.g., after a number of location values have been retrieved.

Displacement motion detection unit 38 may then compare the calculated distance value (or values) to a threshold distance value (126). In examples that use more than two distance values, displacement motion detection unit 38 may compare each distance value to the threshold, calculate an average (e.g., mean, median, or mode) of the distance values and compare the calculated average to the threshold, to determine whether mobile media device 30 is moving.

In general, when the distance value exceeds the threshold value (“YES” branch of 126), displacement motion detection unit 38 may determine that mobile media device 30 is moving. Accordingly, signal selection unit 36 may cause video decoder 34 to decode video data from mobile video signal 28 (128). On the other hand, when the distance value does not exceed the threshold value (“NO” branch of 126), displacement motion detection unit 38 may determine that mobile media device 30 is not moving. Accordingly, signal selection unit 36 may cause video decoder 34 to decode video data from terrestrial video signal 26 (130).

In either case, after video decoder 34 has decoded the video data from either terrestrial video signal 26 or mobile video signal 28, display 32 may display the decoded video data (132). In this manner, mobile media device 30 may preemptively switch from a terrestrial video signal to a mobile video signal in response to detecting displacement motion, without waiting for a degradation of quality to a user's viewing experience.

In the example of FIG. 4 discussed above, it is assumed that the GPS unit provides data indicative of first and second locations, and that displacement motion detection unit 38 calculates the distance traveled to determine whether mobile media device 30 is moving. However, in other examples, the GPS unit itself performs the calculation of distance traveled and indicates a speed and heading for mobile media device 30. Accordingly, in such examples, displacement motion detection unit 38 may retrieve the speed and heading from the GPS unit and, if the speed exceeds a predetermined threshold, determine that mobile media device 30 is moving.

FIG. 5 is a flowchart illustrating an example method for determining whether a mobile media device is moving using an accelerometer. Although described with respect to mobile media device 30 of FIG. 2 for purposes of explanation, it should be understood that other devices may be configured to perform the method described with respect to FIG. 5. For example, wireless communication device 170 of FIG. 6, described below, may be configured to perform the method of FIG. 5.

In the example of FIG. 5, displacement motion detection unit 38 receives data from an associated accelerometer (150). Displacement motion detection unit 38 also retrieves one or more displacement motion signatures, indicative of displacement motion (152). The displacement motion signatures may be pre-configured by subjecting a device equipped with an accelerometer to various types of displacement motion and observing what types of data generated by the accelerometer indicate displacement motion. For example, a displacement motion signature may correspond to ranges of frequencies and amplitudes of data generated by an accelerometer that generally indicate displacement motion. As an example, an accelerometer-equipped device may be subjected to displacement motion, and data from the accelerometer may be collected over a period of time and processed through filters to identify a threshold that is indicative of displacement motion. The device equipped with the accelerometer may further be subjected to non-displacement motion, such as passing the device between a user's hands, raising, lowering, tilting, or rotating the device, or otherwise moving the device in a way that is not considered displacement motion, to determine what types of data are generated by the accelerometer when the device is not experiencing displacement motion. Accordingly, displacement motion detection unit 38 may also be configured with non-displacement motion signatures. Other methods may also be used to develop signatures indicative of displacement motion as well, as known to those of skill in the art.

Displacement motion detection unit 38 may compare the received accelerometer data to the one or more displacement motion signatures to determine whether mobile media device 30 is moving by executing one or more algorithms that are designed to recognize the one or more displacement motion signatures (154). Displacement motion detection unit 38 may determine whether the received accelerometer data matches a displacement motion signature, e.g., whether the frequency and/or amplitude of the data generated by the accelerometer falls within the ranges of data that indicate displacement motion. When the accelerometer data matches a displacement motion signature (“YES” branch of 154), displacement motion detection unit 38 may determine that mobile media device 30 is moving. Accordingly, signal selection unit 36 may cause video decoder 34 to decode video data from mobile video signal 28 (156). On the other hand, when the accelerometer data does not match any of the displacement motion signatures (“NO” branch of 154), signal selection unit 36 may cause video decoder 34 to decode video data from terrestrial video signal 26 (158). In either case, display 32 displays the decoded video data (160).

FIG. 6 is a block diagram illustrating an example wireless communication device 170 that selects, decodes, and displays video data from either a terrestrial video signal or a mobile video signal of a simulcast depending upon whether wireless communication device 170 determines that it is moving. Wireless communication device 170 may also be considered a mobile media device, and may correspond to mobile media device 30 of FIG. 1. Wireless communication device 170 is an example of a device configured to perform the techniques of this disclosure for selecting either a mobile video signal or a terrestrial video signal of a simulcast based on displacement motion.

In the example of FIG. 6, wireless communication device 170 includes display 172, video encoder-decoder (codec) 174, modulator/demodulator (modem) 176, transceiver 178, processor 180, user interface 182, memory 184, data storage device 185, antenna 186, bus 188, and motion detection unit 190. The components included in wireless communication device 170 illustrated in FIG. 6 may be realized by any suitable combination of hardware, software, and/or firmware. In the illustrated example, the components are depicted as separate units. However, in other examples, the various components may be integrated into combined units within common hardware and/or software. As one example, memory 184 may store instructions executable by processor 180 corresponding to various functions of video codec 174. As another example, display 172 may include a video codec that performs the functions of video codec 174, e.g., encoding and/or decoding video data.

User interface 182 may comprise one or more input interfaces. For example, user interface 182 may include a touch screen, a keypad, buttons, a microphone, a speaker, or other interfaces. A user may select a program to view using user interface 182, and the selected program may be simulcast as a terrestrial video signal and a mobile video signal.

Wireless communication device 170 may select to receive encoded video segments from a terrestrial video signal or a mobile video signal of a simulcast based on whether wireless communication device 170 is moving, in accordance with the techniques of this disclosure. In some examples, wireless communication device 170 may store received video data in data storage device 185. To display an encoded video segment in data storage device 185, such as a recorded video segment or a received video segment, video codec 174 may decode the video segment and send decoded frames of the video segment to display 172. When a video segment includes audio data, video codec 174 may decode the audio, or wireless communication device 170 may further include an audio codec (not shown) to decode the audio.

Motion detection unit 190 may be configured to determine whether wireless communication device 170 is moving. Motion detection unit 190 may comprise, for example, a motion sensor, an accelerometer, and/or a GPS unit. Memory 184 may store instructions to cause processor 190 to determine whether wireless communication device 170 is moving, to determine whether to select video data from a terrestrial video signal or a mobile video signal of a simulcast based on whether wireless communication device 170 is determined to be moving, and to decode and display video data from the selected signal.

As an example, motion detection unit 190 may comprise an accelerometer. Memory 184 may store one or more signatures for data produced by the accelerometer indicative of whether wireless communication device 170 is moving, as well as executable instructions for one or more algorithms to recognize the one or more signatures. Motion detection unit 190 may output data to bus 188 that is received and processed by processor 180 to determine whether the data indicates that wireless communication device 170 is moving. Processor 180 may compare the data from motion detection unit 190 to the signatures stored in memory 184 to make this determination by executing the instructions for recognizing the signatures. Moreover, processor 190 may be configured to select a terrestrial video signal or a mobile video signal of a simulcast based on the determination. When processor 190 determines that wireless communication device 170 is moving, processor 190 may select the mobile video signal, whereas when processor 190 determines that wireless communication device 170 is not moving, processor 190 may select the terrestrial video signal.

As another example, motion detection unit 190 may comprise a GPS unit. Processor 180 may periodically determine a current location of wireless communication device 170 by querying the GPS unit. Processor 180 may further be configured to calculate the distance between the determined locations of wireless communication device 170 over a period of time. Memory 184 may store a threshold distance that can be traveled over a period of time that corresponds to whether wireless communication device 170 is moving. Accordingly, processor 180 may compare the calculated distance to the threshold stored in memory 184 to determine whether wireless communication device 170 is moving, and select video data from either a terrestrial video signal or a mobile video signal of a simulcast accordingly. That is, when the calculated distance exceeds the threshold, processor 180 may select video data from the mobile video signal, and when the calculated distance does not exceed the threshold, processor 180 may select video data from the terrestrial video signal.

In still another example, motion detection unit 190 may comprise both a GPS unit and an accelerometer. Motion detection unit 190 may use the accelerometer and the GPS unit in different phases of motion detection. For example, motion detection unit 190 may gather data from the accelerometer during a first motion detection phase to determine whether displacement motion is likely. When displacement motion is determined to be likely, motion detection unit 190 proceeds to the second phase, during which motion detection unit 190 may activate the GPS unit and perform the techniques described above with respect to the GPS unit to determine whether wireless communication device 170 is moving. As another example, the accelerometer and the GPS unit may operate simultaneously and provide respective data that motion detection unit 190 treats as different factors in a decision as to whether wireless communication device 170 is moving. Motion detection unit 190 may treat the indications from the accelerometer and the GPS unit conjunctively or disjunctively. That is, in some examples, motion detection unit 190 may determine that wireless communication device 170 is moving when either or both the accelerometer or the GPS unit indicate motion, while in other examples, motion detection unit 190 may determine that wireless communication device 170 is moving only when both the accelerometer and the GPS unit indicate motion.

In some examples, wireless communication device 170 may additionally include a camera for capturing video data, in which case video codec 174 may encode the captured video data for storage in data storage 185 or transmission via modem 176, transceiver 178, and antenna 186. A user may interact with user interface 182 to transmit a recorded video segment in data storage device 185 to another device, such as another wireless communication device, via modem 176, transceiver 178, and antenna 186. Video codec 174 may be configured to operate according to one or more encoding standards, such as MPEG-2, MPEG-3, MPEG-4, H.263, H.264, or other video encoding standards. In this manner, video codec 174 may perform both the functions of an encoder and of a decoder.

Memory 184 may be encoded with computer-readable instructions that cause processor 180 to perform various tasks, in addition to storing encoded video data. Such instructions may be loaded into memory 184 from a data storage device such as data storage 185. For example, the instructions may cause processor 180 to perform the functions of video codec 174, the triggering of video recording for display 172, such as selection of a terrestrial video signal or a mobile video signal based on whether wireless communication device 170 is moving, determining whether wireless communication device 170 is moving, or other functions.

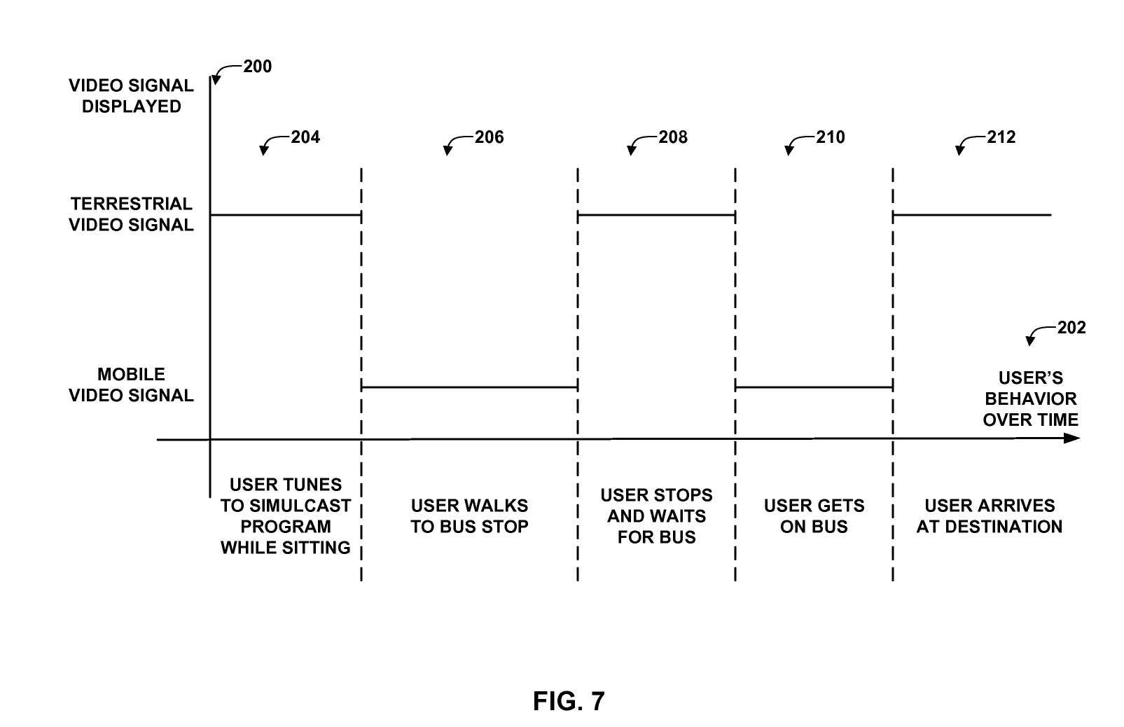

FIG. 7 is a conceptual diagram illustrating an example operation of mobile media device 30 during a portion of an example user's day. FIG. 7 indicates activities that a user participates in over time while watching a simulcast program throughout the portion of the day represented by FIG. 7 along x-axis 202. FIG. 7 also indicates which signal of the simulcast, e.g., either a terrestrial video signal or a mobile video signal, mobile media device 30 uses to display video data during the corresponding activity along y-axis 200.

In the example of FIG. 7, the user begins by tuning to a simulcast program while sitting down during time period 204. Because the user is sitting down, mobile media device 30 determines that it is not moving, even though the user may be moving mobile media device 30, e.g., passing mobile media device 30 between the user's hands or moving mobile media device 30 from side to side, up and down, or rotationally. During any of these activities, mobile media device 30 may continue to determine that mobile media device 30 is not moving, and therefore, may continue to display video data from the terrestrial video signal.

During time period 206, the user stands up and walks to the bus stop. Because the user is walking to a new location, mobile media device 30 may detect that mobile media device 30 is moving. Accordingly, mobile media device 30 may switch to displaying video data from the mobile video signal of the simulcast.

During time period 208, the user stops at the bus stop and waits for the bus. Mobile media device 30 may therefore determine that it is no longer moving and may therefore display video data from the terrestrial video signal. However, after the user boards and begins to ride the bus, as indicated during time period 210, mobile media device 30 may determine that it is again experiencing displacement motion, and may again switch to displaying video data from the mobile video signal. Finally, when the user ultimately arrives at the destination, mobile media device 30 may once again detect that it is no longer moving, and again may display video data from the terrestrial video signal.

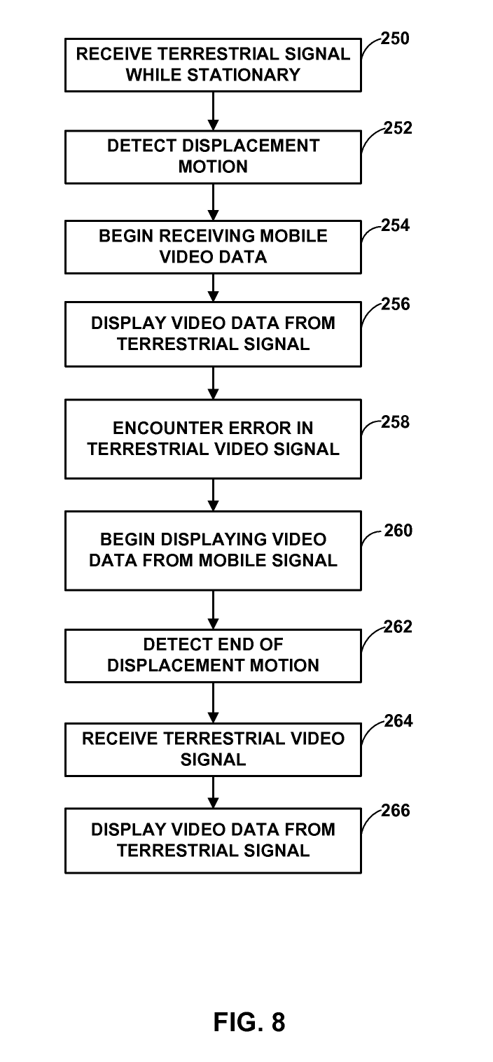

FIG. 8 is a flowchart illustrating an example method for determining whether to receive video data from a mobile video signal of a simulcast based on displacement motion. Although described with respect to mobile media device 30 of FIG. 2 for purposes of explanation, it should be understood that other devices may be configured to perform the method described with respect to FIG. 8. For example, wireless communication device 170 of FIG. 6 may be configured to perform the method of FIG. 8. In general, the method of FIG. 8 is similar to that of FIG. 3, except that the method of FIG. 8 includes beginning to receive a mobile video signal of a simulcast in response to detecting motion, but switching to the mobile video signal after experiencing an error in receiving and/or displaying data from the terrestrial video signal.

In the example of FIG. 8, mobile media device 30 initially receives a terrestrial video signal of a simulcast while mobile media device 30 is stationary (250). It is presumed that mobile media device 30 begins the method of FIG. 8 in a stationary state. While receiving the terrestrial, mobile media device 30 decodes and displays video data from the terrestrial video signal. That is, while stationary, signal selection unit 36 activates terrestrial signal input interface 40 to receive the terrestrial signal and passes data from the terrestrial signal to video decoder 34 for decoding, which passes the decoded video data to display 32 for display.

At some point in the future, displacement motion detection unit 38 determines that mobile media device 30 is moving (252), that is, undergoing displacement motion. Displacement motion detection unit 38 may use any technique for determining that mobile media device 30 is moving, including any of the techniques described in this disclosure. In response to detecting movement, signal selection unit 36, in the example of FIG. 8, activates mobile signal input interface 42 to begin receiving data from a mobile signal of the simulcast (254), which video decoder 34 decodes. However, mobile media device 30 continues to display video data from the terrestrial signal (256), despite having detected the movement. In this manner, mobile media device 30 receives video data from both the terrestrial signal and the mobile signal, in preparation for switching to the mobile signal. Although in the example of FIG. 8, mobile media device 30 receives data from the mobile signal and then displays data from the terrestrial video signal, in other examples, mobile media device 30 may display the data from the terrestrial signal and then receive data from the mobile signal (e.g., as discussed above with respect to FIG. 3), such that video data from each signal need not be simultaneously received.

In the example method of FIG. 8, mobile media device 30 continues to display video data from the terrestrial signal until an error is encountered in displaying the video data from the terrestrial signal. Upon encountering an error with the terrestrial signal (258), mobile media device 30 begins displaying video data from the mobile signal (260). Because mobile media device 30 has prepared for switching to the mobile signal in response to detecting displacement motion, the switch to displaying video data from the mobile signal can be faster than simply detecting the error without detecting motion, which may improve the user's viewing experience.

After switching to the mobile signal, mobile media device 30 continues to display video data from the mobile signal until displacement motion detection unit 38 detects that mobile media device 30 has stopped moving (262). Signal selection unit 36 then causes terrestrial signal input interface 40 to begin receiving the terrestrial signal (264), which is also decoded by video decoder 34. Once video data from the terrestrial signal is ready to be displayed (while mobile media device 30 is stationary), mobile media device 30 again begins displaying video data from the terrestrial signal (266) and stops receiving video data from the mobile signal, until mobile media device 30 again begins moving.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method comprising:
displaying, with a mobile media device, video data from a terrestrial signal of a simulcast broadcast when the mobile media device does not detect displacement motion; and
displaying, with the mobile media device, video data from a mobile signal of the simulcast broadcast when the mobile media device detects displacement motion.

2. The method of claim 1, wherein the terrestrial signal comprises an Advanced Television Systems Committee (ATSC) terrestrial signal, and wherein the mobile signal comprises an ATSC mobile/handheld (ATSC-M/H) signal.

3. The method of claim 1, wherein the terrestrial signal comprises an Integrated Services Digital Broadcasting (ISDB) full-segments transmission, and wherein the mobile signal comprises an ISDB one-segment transmission.

4. The method of claim 1, wherein the terrestrial signal comprises a Digital Video Broadcast (DVB) terrestrial (DVB-T) signal, and wherein the mobile signal comprises a DVB handheld (DVB-H) signal.

5. The method of claim 1, further comprising determining, with a displacement motion detection unit of the mobile media device, whether the mobile media device is moving.

6. The method of claim 5, wherein determining comprises determining whether the mobile media device is moving with at least one of a motion sensor, an accelerometer, or a global positioning system (GPS).

7. The method of claim 5, wherein the displacement motion detection unit comprises a GPS unit, and wherein determining whether the mobile media device is moving comprises:
determining a first location using the GPS unit at a first time;
determining a second location using the GPS unit at a second time;
calculating distance between the first location and the second location; and
determining that the mobile media device is moving when the calculated distance exceeds a threshold.

8. The method of claim 5, wherein the displacement motion detection unit comprises an accelerometer, and wherein determining whether the mobile media device is moving comprises:
receiving motion data from the accelerometer;
comparing the motion data to a displacement motion signature; and
determining that the mobile media device is moving when the motion data matches the displacement motion signature.

9. The method of claim 1, further comprising:
when the mobile media device does not detect displacement motion, selecting to receive and decode data from the terrestrial video signal; and
when the mobile media device detects displacement motion, selecting to receive and decode data from the mobile video signal.

10. An apparatus comprising:
a display configured to display video data; and
a signal selection unit configured to determine whether the apparatus is moving, wherein the signal selection unit is configured to cause the display to display video data from a terrestrial signal of a simulcast broadcast when the signal selection unit does not detect displacement motion, and wherein the signal selection unit is configured to cause the display to display video data from a mobile signal of the simulcast broadcast when the signal selection unit detects displacement motion.

11. The apparatus of claim 10, wherein the terrestrial signal comprises an Advanced Television Systems Committee (ATSC) terrestrial signal, and wherein the mobile signal comprises an ATSC mobile/handheld (ATSC-M/H) signal.

12. The apparatus of claim 10, wherein the terrestrial signal comprises an Integrated Services Digital Broadcasting (ISDB) full-segments transmission, and wherein the mobile signal comprises an ISDB one-segment transmission.

13. The apparatus of claim 10, wherein the terrestrial signal comprises a Digital Video Broadcast (DVB) terrestrial (DVB-T) signal, and wherein the mobile signal comprises a DVB handheld (DVB-H) signal.

14. The apparatus of claim 10, wherein the apparatus further comprises a displacement motion detection unit configured to determine whether the apparatus is moving.

15. The apparatus of claim 14, wherein the displacement motion detection unit comprises at least one of a motion sensor, an accelerometer, or a global positioning system (GPS).

16. The apparatus of claim 14, wherein the displacement motion detection unit comprises a GPS unit, and wherein to determine whether the apparatus is moving, the displacement motion detection unit is configured to determine a first location using the GPS unit at a first time, determine a second location using the GPS unit at a second time, calculate distance between the first location and the second location, and determine that the apparatus is moving when the calculated distance exceeds a threshold.

17. The apparatus of claim 14, wherein the displacement motion detection unit comprises an accelerometer, and wherein to determine whether the apparatus device is moving, the displacement motion detection unit is configured to receive motion data from the accelerometer, compare the motion data to a displacement motion signature, and determine that the apparatus is moving when the motion data matches the displacement motion signature.

18. The apparatus of claim 10, wherein the signal selection unit is configured to select the terrestrial video signal when the signal selection unit does not detect displacement motion and to select the mobile video signal when the signal selection unit detects displacement motion.

19. The apparatus of claim 10, wherein the apparatus comprises at least one of:
an integrated circuit;
a microprocessor, and
a wireless communication device that includes the signal selection unit and the display.

20. A mobile media apparatus comprising:
means for displaying video data from a terrestrial signal of a simulcast broadcast when the mobile media apparatus does not detect displacement motion; and
means for displaying video data from a mobile signal of the simulcast broadcast when the mobile media apparatus detects displacement motion.

21. The apparatus of claim 20, wherein the terrestrial signal comprises an Advanced Television Systems Committee (ATSC) terrestrial signal, and wherein the mobile signal comprises an ATSC mobile/handheld (ATSC-M/H) signal.

22. The apparatus of claim 20, wherein the terrestrial signal comprises an Integrated Services Digital Broadcasting (ISDB) full-segments transmission, and wherein the mobile signal comprises an ISDB one-segment transmission.

23. The apparatus of claim 20, wherein the terrestrial signal comprises a Digital Video Broadcast (DVB) terrestrial (DVB-T) signal, and wherein the mobile signal comprises a DVB handheld (DVB-H) signal.

24. The apparatus of claim 20, further comprising means for determining whether the apparatus is moving.

25. The apparatus of claim 24, wherein the means for determining comprise means for determining whether the mobile media apparatus is moving with at least one of a motion sensor, an accelerometer, or a global positioning system (GPS).

26. The apparatus of claim 24, wherein the means for determining whether the apparatus is moving comprise:
means for receiving GPS data;
means for determining a first location of the apparatus using the GPS data at a first time;
means for determining a second location of the apparatus using the GPS data at a second time;
means for calculating distance between the first location and the second location; and
means for determining that the mobile media apparatus is moving when the calculated distance exceeds a threshold.

27. The apparatus of claim 24, wherein the means for displacement motion detection unit comprise:
means for receiving accelerometer data;
means for comparing the accelerometer data to a displacement motion signature; and
means for determining that the mobile media device is moving when the motion data matches the displacement motion signature.

28. The apparatus of claim 20, further comprising:
means for selecting, when the mobile media apparatus does not detect displacement motion, to receive and decode data from the terrestrial video signal; and
means for selecting, when the mobile media apparatus detects displacement motion, to receive and decode data from the mobile video signal.

29. A computer-readable storage medium encoded with instructions for causing a programmable processor of a mobile media device to:
display video data from a terrestrial signal of a simulcast broadcast when the mobile media device does not detect displacement motion; and
display video data from a mobile signal of the simulcast broadcast when the mobile media device detects displacement motion.

30. The computer-readable storage medium of claim 29, wherein the terrestrial signal comprises an Advanced Television Systems Committee (ATSC) terrestrial signal, and wherein the mobile signal comprises an ATSC mobile/handheld (ATSC-M/H) signal.

31. The computer-readable storage medium of claim 29, wherein the terrestrial signal comprises an Integrated Services Digital Broadcasting (ISDB) full-segments transmission, and wherein the mobile signal comprises an ISDB one-segment transmission.

32. The computer-readable storage medium of claim 29, wherein the terrestrial signal comprises a Digital Video Broadcast (DVB) terrestrial (DVB-T) signal, and wherein the mobile signal comprises a DVB handheld (DVB-H) signal.

33. The computer-readable storage medium of claim 29, further comprising instructions to determine whether the mobile media device is moving.

34. The computer-readable storage medium of claim 33, wherein the instructions to determine whether the mobile media device is moving comprise instructions to determine whether the mobile media device is moving with data from at least one of a motion sensor, an accelerometer, or a global positioning system (GPS).

35. The computer-readable storage medium of claim 33, wherein the instructions to determine whether the mobile media device is moving comprise instructions to:
determine a first location of the mobile media device from a GPS unit at a first time;
determine a second location of the mobile media device from the GPS unit at a second time;
calculate distance between the first location and the second location; and
determine that the mobile media device is moving when the calculated distance exceeds a threshold.

36. The computer-readable storage medium of claim 33, wherein the instructions to determine whether the mobile media device is moving comprise instructions to:
receive motion data from an accelerometer;
compare the motion data to a displacement motion signature; and
determine that the mobile media device is moving when the motion data matches the displacement motion signature.

37. The computer-readable storage medium of claim 29, further comprising instructions to:
when the mobile media device does not detect displacement motion, select to receive and decode data from the terrestrial video signal; and
when the mobile media device detects displacement motion, select to receive and decode data from the mobile video signal.

38. A method comprising:
receiving, with a mobile media device, only video data from a terrestrial video signal of a simulcast broadcast;
determining that the mobile media device is moving;
in response to determining that the mobile media device is moving, receiving a mobile video signal of the simulcast broadcast in addition to the terrestrial video signal; and
displaying video data from the terrestrial video signal until an error is encountered.

39. The method of claim 38, further comprising, upon encountering the error, displaying video data from the mobile video signal.

40. The method of claim 38, wherein determining that the mobile media device is moving comprises determining whether the mobile media device is moving with a displacement motion detection unit comprising at least one of a motion sensor, an accelerometer, or a global positioning system (GPS) unit.

41. The method of claim 40, wherein the displacement motion detection unit comprises a GPS unit, and wherein determining whether the mobile media device is moving comprises:
determining a first location using the GPS unit at a first time;
determining a second location using the GPS unit at a second time;
calculating distance between the first location and the second location; and
determining that the mobile media device is moving when the calculated distance exceeds a threshold.

42. The method of claim 40, wherein the displacement motion detection unit comprises an accelerometer, and wherein determining whether the mobile media device is moving comprises:
receiving motion data from the accelerometer;
comparing the motion data to a displacement motion signature; and
determining that the mobile media device is moving when the motion data matches the displacement motion signature.

43. The method of claim 38, further comprising:
determining that the mobile media device is no longer moving; and
in response to determining that the mobile media device is no longer moving, receiving video data from the terrestrial signal and displaying the video data from the terrestrial signal.
